(19) United States
(12) Patent Application Publication
(10) Pub. No.: US 2011/0280217 A1
(43) Pub. Date: Nov. 17, 2011

(54) SUPPORT OF CS DOMAIN SERVICES OVER A PACKET ONLY MOBILE SYSTEM

(76) Inventors: Nicolas Drevon, Nozay (FR); Laurent Thiebaut, Nozay (FR); Alistair Urie, Velizy (FR)

(21) Appl. No.: 13/128,583

(22) PCT Filed: Nov. 9, 2009
(86) PCT No.: PCT/IB2009/007820

§ 371 Date: Jul. 25, 2011

Related U.S. Application Data
(60) Provisional application No. 61/198,865, filed on Nov. 10, 2008.

(51) Int. Cl. H04W 36/14; H04W 4/18

(52) U.S. Cl. 370/331; 370/328

(57) ABSTRACT

In an embodiment, there is provided an architecture for the support of CS domain services over a Packet only mobile system such as the Evolved Packet System access, in a mobile communication system comprising an Evolved Packet System (EPS) and a CS domain in turn comprising at last one Mobile Switching Center MSC, said architecture comprising at least one Interworking Function IWF, such that IWF is perceived as a Radio Network Controller RNC or a Base Station Controller BTS by a MSC, and as an Application Server by the EPS.

### CROSS-REFERENCE TO RELATED APPLICATIONS

This application is a U.S. National Stage entry of PCT International Application No. PCT/IB2009/007820 (filed Nov. 9, 2009) claiming priority to and the benefit of U.S. provisional patent application No. 61/198,865, filed on Nov. 10, 2008, the disclosure of which is hereby incorporated by reference thereto in its entirety.

### FIELD OF THE INVENTION

The present invention generally relates to mobile communication networks and systems. The present invention more particularly but not exclusively relates to the support of CS (Circuit Switched) domain services over a Packet only mobile system such as the EPS (Evolved Packet System).

### BACKGROUND

Generally, descriptions of mobile networks and systems can be found in the literature such as in particular in Technical Specifications published by standardisation bodies, such as for example 3GPP (3rd Generation Partnership Project).

### SUMMARY

In one aspect, in an embodiment, there is provided an architecture for the support of CS domain services over a Packet only mobile system such as the Evolved Packet System access, in a mobile communication system comprising an Evolved Packet System (EPS) and a CS domain in turn comprising at last one Mobile Switching Center MSC, said architecture comprising at least one Interworking Function IWF, such that IWF is perceived as a Radio Network Controller RNC or a Base Station Controller BTS by a MSC, and as an Application Server by the EPS.

In other aspects and other embodiments, different methods are provided for the support of CS domain services over a Packet only mobile system such as the Evolved Packet System access, such as in particular a method for registering to the CS domain to enable CS domain services over Evolved PS access, a method for call setup, a method for handover from E-UTRAN to GERAN/UTRAN.

In other aspects and other embodiments, different entities are provided for the support of CS domain services over a Packet only mobile system such as the Evolved Packet System access, such as in particular Interworking Function IWF, Mobility Management Entity MME for EPS, E-UTRAN entity such as in particular eNB, and User Equipment UE.

### BRIEF DESCRIPTION OF THE FIGURES

Some embodiments of apparatus and/or methods in accordance with embodiments of the present invention are now described, by way of example only, and with reference to the accompanying drawings, in which:

FIG. 1 is intended to illustrate a non-roaming architecture for the support of CS domain services over Evolved Packet System EPS according to an embodiment of the present invention,

FIG. 2 is intended to illustrate a roaming architecture for the support of CS domain services over Evolved Packet System EPS according to an embodiment of the present invention,

FIG. 3 is intended to illustrate a protocol stack for control plane over Z1 interface according to an embodiment of the present invention,

FIG. 4 is intended to illustrate a protocol stack for user plane over Z1 interface according to an embodiment of the present invention,

FIG. 5 is intended to illustrate a registration procedure according to an embodiment of the present invention (first alternative),

FIG. 6 is intended to illustrate a registration procedure according to an embodiment of the present invention (second alternative),

FIG. 7 is intended to illustrate a call setup procedure according to an embodiment of the present invention (first alternative),

FIG. 8 is intended to illustrate a call setup procedure according to an embodiment of the present invention (second alternative),

FIG. 9 is intended to illustrate a SMS procedure according to an embodiment of the present invention,

FIG. 10 is intended to illustrate a procedure for handover from E-UTRAN to GSM UMTS CS according to an embodiment of the present invention.

### DESCRIPTION OF EMBODIMENTS

Embodiments of the present invention relate to the support of CS (Circuit Switched) domain services over a Packet only mobile system such as the EPS (Evolved Packet System).

CS voice over LTE (CS over PS) has already been studied at 3GPP SA2 and several alternatives are described in a technical report TR 23.879. Instead of CS over PS (CSoPS) solution, CS Fallback solution has been specified for Rel-8. It consists in sending the terminal to the GERAN/UTRAN technology to make/receive a call in CS domain. But it has major drawbacks:
If fallback to GERAN, PS sessions (e.g. corporate VPN) are suspended (VPN is broken) when a call is initiated/answered. If fallback to UTRAN, the PS sessions can be kept.
Call setup delay is increased by at least 1 or 2 seconds on each side since the LTE sessions have to be re-established before a handover is performed. Only after that the call setup can proceed.
CS fallback is contradictory with LTE femtos since the voice calls would be setup in the macro network. So, it neither extend the coverage for voice to deep indoor, nor off-load the macro network (90% of usage is voice today).

The already described CS over PS (alternative 1 of TR 23.879) has not the CS Fallback drawbacks, but it implies modifications to the existing MSC base.

Alternative 1 (Evolved MSC) described in 3GPP TR 28.879 has several drawbacks, in particular the fact that there are impacts to installed MSCs.

Some operators want to jump from GSM/EDGE to LTE and minimize investments on WCDMA technology, and therefore to support voice on LTE as soon as possible.

Such operators generally also consider it is not desirable to offer voice services with CS Fallback on 2G because of poor services and performances

They also consider it is impossible for them to deploy IMS, TAS, ICS, SR-VCC in addition to modifications to charging network, subscriber management and customer care by 2012-2013— too costly, too risky, or too short timing.

Embodiments of the present invention in particular enable to solve such problems and/or avoid such drawbacks. More generally, it is an object of embodiments of the present invention to improve support of CS domain services over packet only mobile systems.

Overview

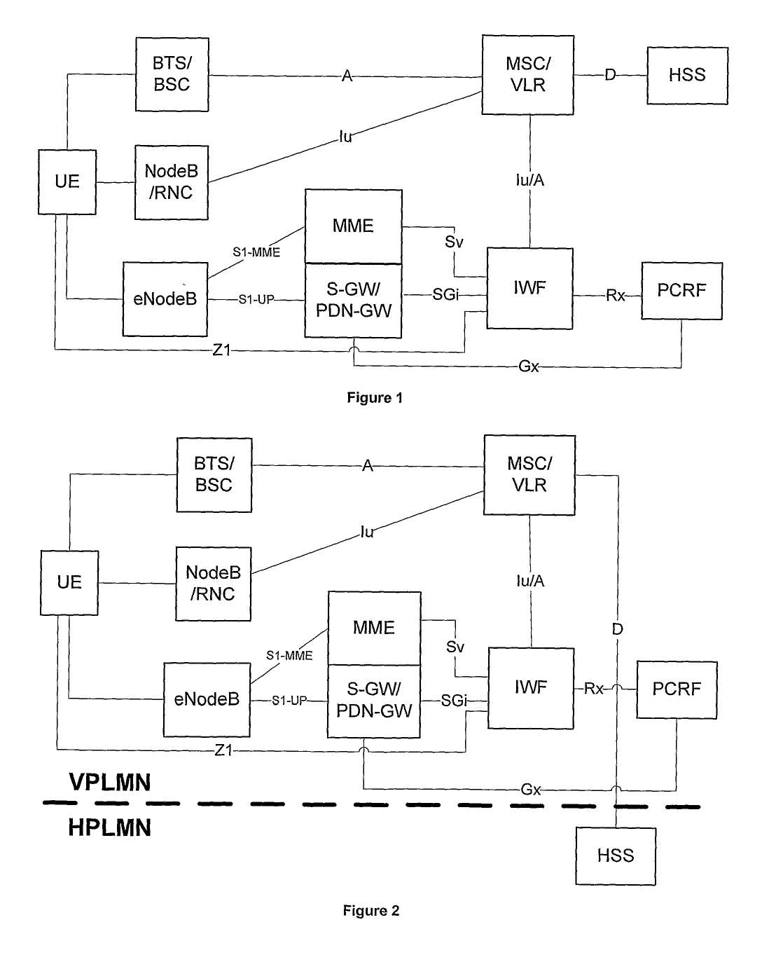

FIG. 1 is intended to illustrate a non-roaming architecture for the support of CS domain services over Evolved Packet System EPS according to an embodiment of the present invention.

In an embodiment, an architecture for the support of CS domain services over a Packet only mobile system such as the EPS is provided, wherein one or several Interworking Function(s) IWF(s) are inserted between EPC and MSC(s), where the IWF would be perceived as a RNC/BSC by the unmodified existing MSC(s).
IWF is perceived as a RNC for the MSC(s). The interface between the IWF and MSC can either be Iu or A.
IWF is perceived as an Application Server by the EPS. Rx interface to PCRF to manage EPS resources.
Sv interface as defined for SR-VCC, i.e. over GTP/UDP/IP, with some additions and modifications.

An Interworking Function (IWF) is included as a new logical entity in the CS over PS architecture between the MSC and the Evolved Packet System (EPS).

It is interfaced to the MSC(s) through standard Iu/A interface.

It is interfaced to the EPS:
through Rx interface to the PCRF for EPS bearer establishment/modification release;
through an evolved Sv interface to the MME used for securing UE binding, for handover procedures, for location reporting procedures, etc;
through SGi interface to the P-GW for carrying the CS Domain NAS signalling between the UE and the MSC, and some specific UE-IWF messages for the establishment/release of a transport reliable UE-IWF Session and for Paging.

It is interfaced to the UE through a new simple Z1 interface, carried over the EPS.

Like TR 23.879 CSoPS alternative 1, it leverages the fact that the UE is already known and managed by the EPS network:
The IWF is a trustable equipment that is connected to MME, PDN-GW, PCRF through secure interfaces (e.g. IPsec aggregate), so that there is no need to cipher the control plane nor the user plane in addition to that.
The UE being registered at EPS before communicating with the IWF and MSC, the MME is aware of the UE location thanks to the TAI and that location is trustable. Therefore, the MME is able to derive a LAI for the UE, and can select an IWF connected to a MSC that handles that LAI. The advantage is that the selection of the IWF and the MSC is under operator's control, and not under UE's control.
The LAI and IWF IP Address are provided to the UE at EPS Attach and EPS Tracking Area Update.
The location provided by the EPS can be reused for location reporting procedures in the CS domain.

IWF is mainly in charge of:
Relaying NAS signalling between P-GW and MSC between SGi and Iu interface
Acting as a RNC for the MSC
Translating RANAP RAB Assignment procedures to/from Establishment/Modifications/Releases of EPS bearers to PCRF through Rx
Relaying handover preparation and execution signalling messages between MME and MSC via Sv and Iu/A interface
Selecting the MSC. May support Iu Flex if necessary
Managing the “UE-IWF Session”

IWF and MSC redundancy
The IWF can be connected to several MSC pools and can support Iu Flex, which makes the redundancy better.
A mechanism for selecting a new IWF in case of IWF or MSC failure is introduced. It consists in the retry of TAU by the UE with a specific flag indicating that another (LAI+IWF IP address) couple should be provided to the UE.

MME, in addition to Rel-8 standard behaviour, is responsible for:
Selecting an IWF, and allocating an LAI to the UE
the signalling exchange with the IWF for CS domain handover preparation and execution through Sv interface.
the signalling with IWF for UE-Binding checks (see further)
the signalling with IWF for CS domain Location Reporting procedures
Signalling a change of MME to the IWF via Sv interface; at MME change, the source MME shall also provides the IWF IP address, the LAI and the UE IP address to the target MME in the MM context (or outside) in order to keep the same IWF.
Location reporting control procedures via Sv interface. The location provided to the MSC is therefore trusted as it comes from the MME.
Receiving the UE CSoPS capability, and sending the UE+Network global CSoPS capability (called “SRVCC operation possible indication”) to the E-UTRAN at call setup e.g. in the S1-AP Initial Context Setup request message.
Splitting the CS bearer from the non-CS bearers and coordinating the CS and PS handovers.

E-UTRAN (eNB) is in charge of:
Taking the decision of CSoPS handover or PS handover depending on the “SRVCC operation possible indication” and the target cell type: if the cell is a LTE cell, it is a PS Handover; if the cell is 2G-3G and supports CS voice only, the handover is a CSoPS handover.
Similar mechanism as the one used for SR-VCC is proposed.

UE Binding
After EPS Attach or TA Update, the MME sends the UE IP address, the IMSI or TMSI and the LAI to the IWF to allow UE binding verification by the IWF, through Sv interface. The LAI would be used for Location Reporting procedures with the MSC.
The IWF verifies the UE binding by checking whether the Temporary User Identity (e.g. GUTI) or Permanent User Identity (e.g. IMSI) received in UE-IWF messages corresponding to the UE IP address matches with the Temporary User Identity (e.g. GUTI) or Permanent User Identity (e.g. IMSI) provided by the MME in the UE-Binding message.

Advantages Summary
It leverages the fact that the UE is already known and managed by the EPS network, so it simplifies the security mechanisms and does not require Security Gateways to protect the CS over PS access to the IWF/MSC.
It simplifies the allocation of the IWF as it is done by the MME, and thus controlled by the operator.
It allows Iu-Hex as the MSC is allocated by the IWF.
The location provided by the EPS can be reused for location reporting procedures in the CS domain. This provide trustability of the location.
The IWF supports a transparent relay of NAS CS Domain messages and procedures with a simple Z1 container protocol without RRC like procedures, that makes it as simple as possible.
MME change is supported without the need to change IWF.
IWF or MSC connectivity failure is supported as the UE will re-attach or make a TAU to get new IWF IP address and new LAI.
It may be possible to reuse the SR-VCC mechanisms and therefore to avoid changes in the E-UTRAN and UE.

FIG. 1 is intended to illustrate a non-roaming architecture for the support of CS domain services over Evolved Packet System EPS according to an embodiment of the present invention.

The operator chooses to reuse existing MSC's without modifications, and to introduce a new IWF that will control establishment of voice calls and handling of SMS under E-UTRAN coverage. From the EPS point of view, the IWF is perceived as an Application Server. Thus the functionality of Z1 interface can be compared to that of Gm reference point. From MSC point of view, the IWF is perceived as a RNC.

FIG. 2 is intended to illustrate a roaming architecture for the support of CS domain services over Evolved Packet System EPS according to an embodiment of the present invention.

If the Visited PLMN supports “CS domain services over evolved PS access” (CSoPS), an architecture as illustrated in FIG. 2 may apply where the PDN GW and the IWF are both located in the VPLMN. In order to allow operators to limit user-plane traffic through the PDN-GW in the VPLMN to user-plane traffic related to CSoPS service, it shall be possible to have a separate APN for CSoPS.

If the Visited PLMN does not support “CS domain services over evolved PS access”, the subscriber will not have access to CS domain voice calls over EPS.

Required Functionality in Network Elements

In an embodiment:

IWF Contains Following Functionality:
Relaying NAS signalling between P-GW and MSC between SGi and Iu interface
Acting as a RNC for the MSC
Translating RANAP RAB Assignment procedures to/from Establishment/Modifications/Releases of EPS bearers to PCRF through Rx
Relaying handover preparation and execution signalling messages between MME and MSC via Sv and Iu/A interface
Verifying the UE binding i.e. checking whether the Temporary User Identity (e.g. GUTI) or Permanent User Identity (e.g. IMSI) received in UE-IWF messages corresponding to the UE IP address matches with the Temporary User Identity (e.g. GUTI) or Permanent User Identity (e.g. IMSI) provided by the MME in the UE-Binding message.
Selecting the MSC. May support Iu Flex if necessary
Managing the “UE-IWF Session”

MME Additional to Rel-8 Standard Behaviour:
Selecting an IWF, and allocating an LAI to the UE
Signalling exchange with the IWF for CS domain handover preparation and execution through Sv interface.
Signalling to the IWF to allow UE binding verification by the IWF via Sv interface
Signalling a change of MME to the IWF via Sv interface
At MME change, the source MME shall send the IWF IP address to the target MME
Location reporting control procedures via Sv interface
Combining the “CSoPS” (CS over PS) UE capability received from the UE with the Network CSoPS capability and sending a “SRVCC operation possible indication” to the E-UTRAN at call setup.
Initiating a CS handover through Sv interface by relaying the HO Required to IWF.
Splitting the CS bearer from the non-CS bearers and coordinating the CS and PS handovers

UE Additional to Rel-8 Standard Behaviour:
NAS CS domain signalling, including Mobility Management, Call Control and SMS, over reliable IP transport
Encapsulation of NAS CS domain signalling messages in container that is intended to carry e.g. IWF IP address and MSC identifier.
Transferring CSoPS UE capability to the MME at EPS Attach

E-UTRAN (eNB)
Decision of CSoPS handover or PS handover depending on the “SRVCC operation possible indication” received from the MME and on the target cell type
Similar mechanism as the one used for SR-VCC; indicating un HO Required to the MME that the handover is a CSoPS handover or not.

In an embodiment:
IWF functionality
   Relaying NAS signalling between P-GW and MSC between SGi and Iu/A interface
   Acting as a RNC for the MSC
   Translating RANAP/BSSAP RAB Assignment procedures to/from Establishment/Modifications/Releases of EPS bearers to PCRF through Rx
   Relaying handover preparation and execution signalling messages between MME and MSC via Sv and Iu interface
   Verifying the UE binding i.e. between TMSI/IMSI and UE IP address
   Managing the “UE-IWF Session”
   Selecting the MSC. Can support Iu Flex if necessary
MME changes against Rel-8
   Sv on GTP/UDP/IP but with additions for signalling exchange with the IWF for CS domain handover preparation and execution
   Sv signalling to the IWF to allow UE binding verification by the IWF (Alternative Reg-B)
   Other additional messages/parameters to Sv such as Location Reporting procedures
   Knowledge of CSoPS UE capability.
   Selecting IWF, allocating the LAI to the UE. Selecting another IWF, allocating another LAI if requested by the UE at re-Attach or TAU (to solve IWF or MSC loss of connectivity with the UE).
   Transfer of IWF IP address and LAI from sourced MME to target MME at MME change.
UE changes against Rel-8
   NAS CS domain signalling, including Mobility Management, Call Control and SMS, over reliable IP transport
   Encapsulation of NAS CS domain signalling messages in container that is intended to carry e.g. IWF IP address and MSC identifier
   Transferring CSoPS UE capability to the MME at Attach
   IWF/MSC discovery (Alternative Reg-A)
   Re-Attach (or TAU) when no response to LA Update Request with “specific flag” set (to solve IWF or MSC loss of connectivity with the UE)
E-UTRAN (eNB)
   Decision of CSoPS handover or PS handover depending on target cell type
   Could be similar mechanism as the one used for SR-VCC
   Could even be same parameters as in SR-VCC, avoiding changes in eNB

Reference Points

Z1: Reference point between UE and IWF.

Sv: Reference point between MME and IWF.

Protocol Stacks

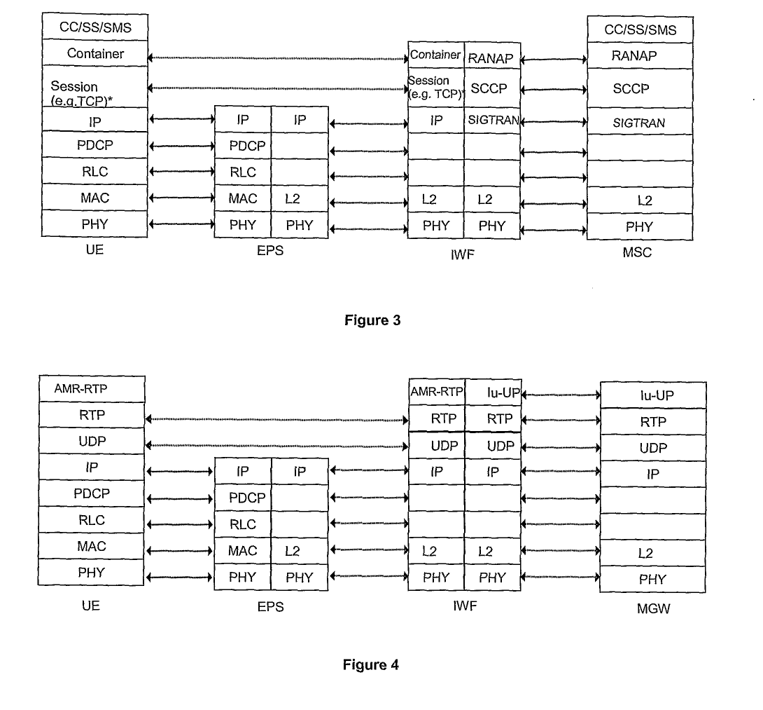

A protocol stack for control plane over Z1 is illustrated in FIG. 3.
“Container” protocol is intended to encapsulate the 24.008/24.011 NAS CS domain messages into IP packets containing UE IP@, IWF IP@
A “UE-IWF Session” (TCP, SCTP or other IP reliable protocol) is established between the UE and the IWF
No need to have IPSec tunneling which is costly (Security GW) and counter-performing: LTE radio is already secure
UE binding (IMSI/TMSI, UE IP address) checks are performed by IWF.
Note: The “UE-IWF Session” layer may be SCTP or TCP or another retransmission protocol. This layer should be selected in order to avoid terminal battery drain.
Note: The “Container” protocol may be a new one or may be SIP, “Container” protocol is intended to encapsulate the 24.008/24.011 NAS CS domain messages into IP packets containing UE IP address, IWF IP address, LAI.
Note: Iu over IP Transport is proposed as interface, but Iu over ATM, A over PCM or A over IP transport may be used as options.

A protocol stack for user plane over 71 is illustrated in FIG. 4.
Iu-UP protocol is necessary at Iu interface: it is used to initiate CN transcoders and to negotiate AMR mode changes.
It is extended up to the UE thanks to the AMR RTP Framing protocol IETF RFC 4867

Note: Iu UP protocol in IWF and necessary related mechanisms between IWF and UE may be used.

Procedures

Attach and Registration—Alternative REG-A (Discovery by the UE)

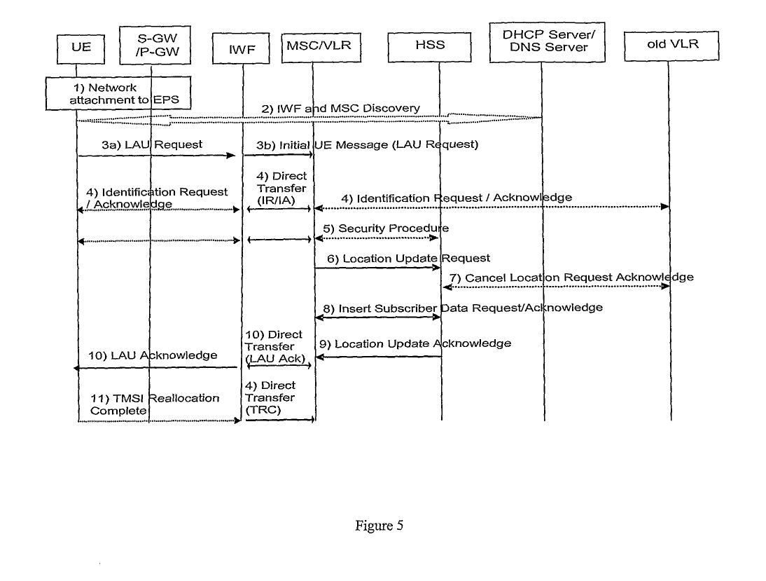

FIG. 5 is intended to illustrate a registration procedure according to an embodiment of the present invention (first alternative).
The Attach Request message includes the UE CSoPS capability. This is needed for further handovers to know whether the MME has to make a PS handover or a CSoPS handover through Sv interface
   The UE discovers the couple of (IWF IP address, LAI) to which it will send the 24.008 registration messages. The IWF IP@ is the destination address to be used for CS domain NAS messages by the UE, and LAI unambiguously identifies the MSC pool (in case of Iu Flex from IWF). They can be either delivered to the UE via Attach Accept message or discovered using DHCP and DNS query
   The IWF will register to the MME at call setup only—no need before.

Attach and Registration—Alternative REG-B (Selection of IWF by the MME, Selection of MSC by the IWF)

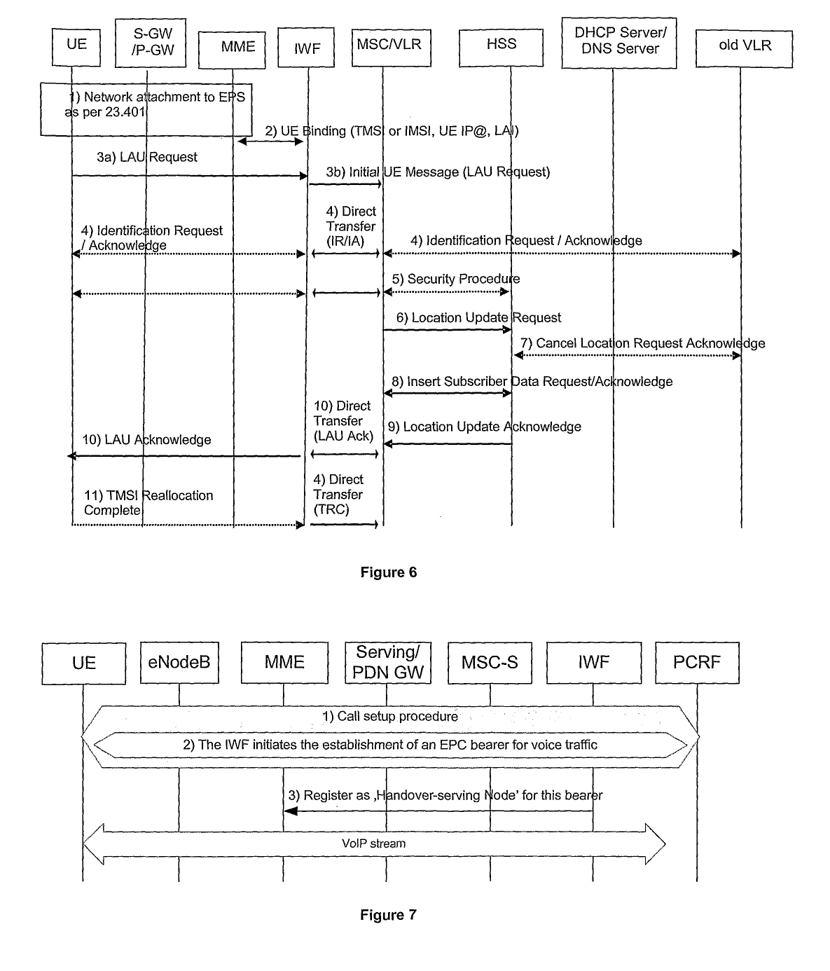

FIG. 6 is intended to illustrate a registration procedure according to an embodiment of the present invention (second alternative).

After having attached to the EPS network, the UE shall attach and register to the CS Domain to enable CS Domain services.
1) The UE registers to the network according to the Attach procedure as specified in TS 23.401 with additional parameter CSoPS UE capability. The Default Bearer can be used to carry 24.008 signalling messages. A dedicated bearer may also be setup for this purpose if needed for better QoS. The MME gets the subscriber's IMSI from the EPS authentication procedure and the IP address allocated by the P-GW during Attach procedure. If the UE is CSoPS capable, the MME selects the IWF from the TAI and allocates a LAI (which could be e.g. equal to TAI), then returns IWF IP address and LAI to the UE with Attach Accept.
2) The MME sends UE Binding (Temporary User Identity (e.g. GUTI) or Permanent User Identity (e.g. IMSI), UE IP address, LAI) to the IWF. The IWF stores these information and selects the MSC in the pool of MSC's that manage the LAI. This avoids the IWF to be obliged to extract the NAS messages sent by the UE to know the LAI.
Note: The UE Binding may be sent after Attach procedure or during the Attach procedure. It may be required that it is an exchange between MME and IWF during the Attach procedure to avoid the UE to send an LAU Request before the IWF is aware of the binding. It should be possible to send UE Binding after the Attach procedure if the IWF waits for it if it receives the LAU Request from the UE before.
3a) The UE establishes a “UE-IWF session” (e.g. TCP connection) with the IWF. If the LAI is changed or not known by the UE, the UE initiates the registration procedure by sending Location Updating Request message per TS 24.008 to the IWF. This message is packed into IP packets including UE IP address and IWF IP address. If the LAI is unchanged compared to the LAI stored in the UE, the UE is not mandated to initiate LA Update procedure.
3b) IWF stores the UE IP address and the IWF IP address from the “container” and checks whether these information match to the information sent by the MME in the UE Binding message from MME, if already received. If the UE Binding message is not received yet, the IWF waits for it. If the binding check is successful, the IWF establishes a SCCP connection with the MSC selected by the MME. Then it encapsulate the 24.008 message into a RANAP Initial UE Message and sends it to the MSC.
4) Per TS 24.008, the MSC/VLR obtains the IMSI and authentication data about the UE from the old VLR if the UE identifies itself with TMSI and VLR changes since last deregistration. If the UE identifies itself with TMSI and the TMSI is unknown in both the old and new VLR, the new VLR get the IMSI from the UE. The NAS messages over the MSC/IWF interface are encapsulated in RANAP Direct Transfer messages per TS 25.413.
5) The MSC may perform the security procedure between the MSC and the UE per 24.008.
6) The MSC/VLR registers itself to the HSS by sending a Location Update request (IMSI, MSC Address, VLR number etc) message.
7) HSS initiates the cancel location procedure to the old VLR.
8) The MSC/VLR obtains the subscription data from HSS. The MME address is included in the Subscription Data.
9) HSS responds with Location Update Acknowledge to the MSC/VLR.
10) The MSC/VLR sends the Location Update Accept (new LAI, new TMSI) to the UE through the IWF by encapsulating the NAS message in a RANAP Direct Transfer message. The UE is now “CS over PS” attached in the IWF.
Note: The way how the UE IP address and the IWF IP address is transmitted does not need to be further detailed. A new container protocol, known by the UE, could carry this new field with no impact on 24.008 signalling.
11) The UE sends the TMSI Reallocation Complete message to indicate the network that the reallocation of TMSI is accepted.

Note: The MSC will, according to operator policy, allow an emergency registration with an IMEI as UE identification, and subsequently not perform authentication procedure

Alternative REG-B may be recommended.

In alternative REG-B:
The Attach Request message includes UE CSoPS capability, TMSI, old LAI. If the UE is CSoPS capable, MME selects the IWF and the MSC from the TAI and returns the IWF IP@ and the MSC-ID to the UE with Attach Accept.
If the IWF IP@ is changed or was not known, the UE initiates registration procedure by sending LAU Request (IMSI or TMSI, old LAI) message to the IWF. This message is packed into IP packets including UE IP@, IWF IP@ and MSC-ID.
IWF stores IMSI/TMSI, old LAI, UE IP@ and MSC-ID for the UE and checks UE IP@ against TSMI/IMSI. If UE Binding message is not received yet, IWF waits for it before checking UE binding. If binding check is successful, IWF establishes a SCCP connection with the MSC and encapsulates 24.008 message into a RANAP Initial UE Message towards the MSC.

Location Update

The UE performs periodic location updates as specified in TS 23.012. The UE initiates LA Update procedure if the LAI provided in the TAU Accept is different from the LAI stored in the UE.

Up to now no reason has been identified which would require changing MSC when changing TA as long as IWF and MSC are available.

In case of IWF or MSC failure or in case of no connectivity to IWF or MSC with the UE, following mechanism can be used: If there is no answer to LA Update Request or if the “UE-IWF Session” has been released, the UE performs an Attach or a TAU to the EPS. The MME will allocate a new IWF IP address and a new LAI to the UE. A specific flag or parameter could be added to the 23.401 Attach and TAU messages to indicate to the MME that it should allocate a new IWF IP address and a new LAI.

In case e.g. the IWF wants to change the MSC allocated to the UE, the IWF can release the “UE-IWF Session”. The UE can react to that by performing an Attach or a TAU to the EPS with the above mentioned flag set, and the above mechanism applies i.e. the MME will allocate a new IWF IP address and a new LAI to the UE.
No reason has been identified which would require changing MSC when changing TA
Alternative Reg-A: If a change of MSC at time of TA change is desired, the UE could in case of a TA change do an MSC Discovery, and then, if a new MSC has been assigned, do a location update to the new MSC
Alternative Reg-B: The UE initiates LA Update procedure if the LAI provided in the TAU Accept is different from the one stored in the UE

EPS Detach Procedure

When the UE is detached (whatever the reason) from EPS, the MME releases the Sv connection with the IWF, allowing the IWF to release the associated resources:
EPS resources via Rx
SCCP connection to the MSC
UE-IWF-session with the UE
Internal resources.

Providing the Cell-Id to the MSC on the Interface Between the IWF and the MSC

For all Uplink signalling sent towards the MSC over the UE-IWF-session, the UE adds the cell-identifier (corresponding to the LTE coverage).

The IWF maps this information to a relevant Cell-Id to be passed to the MSC (and to be used by the MSC e.g. to determine an emergency centre, . . . )

In case the MME and the IWF are co-located, the IWF can check that the information provided from the UE is accurate at the cell-Id level.

In case the MME and the IWF are not co-located, the IWF checks the validity of the information at the level of the Tracking Area list.

Impacts to 23.401 Related to Mobility Management

In both idle and connected modes, a change of serving MME will be signalled from the new MME to the IWF via Sv interface. At MME change, even in idle mode, the couple (IWF IP address and LAI) shall be transferred by the old MME to the new MME in the MM context.

Originating Call Setup—Alternative REG-A (Discovery by the UE)

FIG. 7 is intended to illustrate a call setup procedure according to an embodiment of the present invention (first alternative).
Call Setup is performed via 24.008 messages conveyed:
   in IP packets with container between UE and IWF
   in RANAP Initial UE message and Direct Transfer messages over Iu
No need to cipher. IWF should accept Ciphering Mode Command from the MSC and just answering positively without any other processing.
RAB Assignment messages are converted into Rx messages towards PCRF to allocate EPS bearers to carry voice
IWF registers to MME for further handovers at call setup: the MME will need to relay HO Required message from eNB to IWF. A change of serving MME will be signalled from the new MME to the IWF.

Originating Call Setup—Alternative REG-B IWF and MSC Selection by the MME)

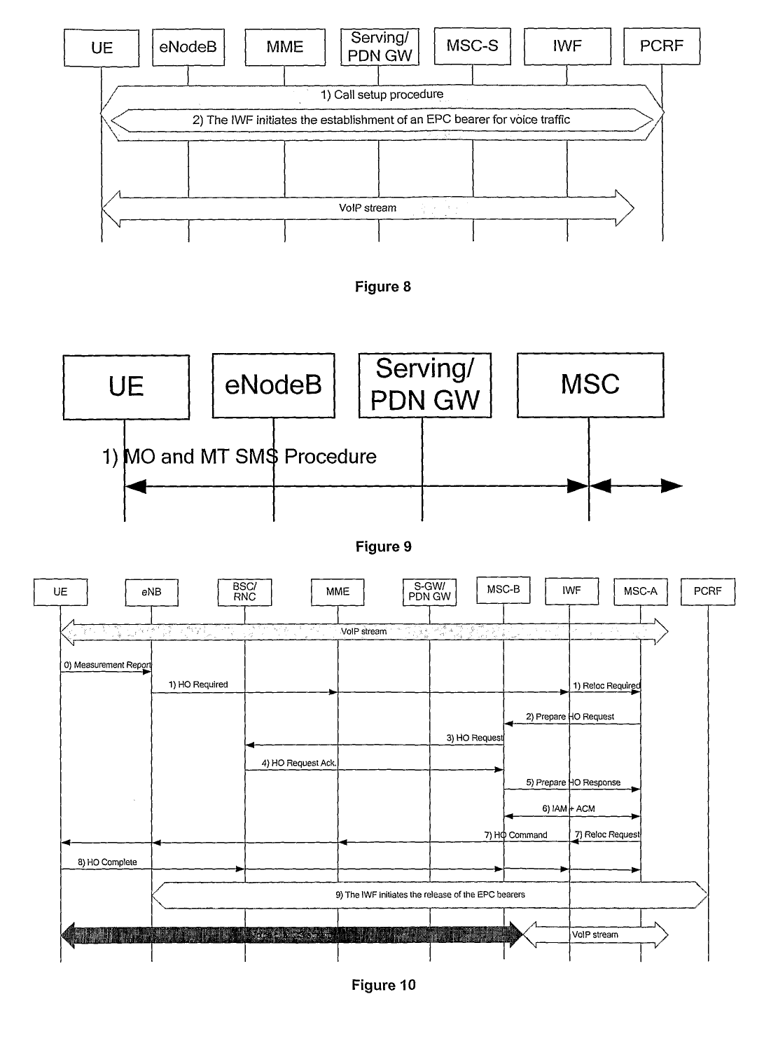

FIG. 8 is intended to illustrate a call setup procedure according to an embodiment of the present invention (second alternative).
Call Setup is performed via 24.008 messages conveyed:
   in IP packets with container between UE and IWF
   in RANAP Initial UE message and Direct Transfer messages over Iu
No need to cipher. IWF should accept Ciphering Mode Command from the MSC and just answering positively without any other processing.
RAB Assignment messages are converted into Rx messages towards PCRF to allocate EPS bearers to carry voice
IWF registers to MME for further handovers at call setup: the MME will need to relay HO Required message from eNB to IWF. A change of serving MME will be signalled from the new MME to the IWF.
1) The call setup takes place as specified in TS 23.018 (with the exception of CS channel allocation that is described in step 2) and is transported over the UE-IWF Session. Ciphering is performed at eNB-UE level and is not required at MSC level. However, the IWF should accept the Ciphering Mode Command from the MSC and just answering positively without any other processing.
In this procedure, and after the establishment of the EPC bearer, the UE obtains the MGW IP address.
Note: The way how the IP address of the MGW is transmitted does not need to be further detailed. The impacted messages could be “Alerting” for MO calls and “Call setup” for MT calls. A new container protocol, known by the UE, could carry this new field with no impact on TS 24.008 signalling.
2) Upon receipt of RANAP RAB Assignment Request from the MSC, the IWF initiates the EPC bearer for the voice stream according to ‘IP-CAN Session Modification; PCRF initiated’ procedure as specified in TS 23.203.

Terminating Call Setup
For MT call setup, when the IWF receives the Paging message from the MSC, it sends a specific “CS Paging” message to the UE. The UE will respond with a NAS 24.008 Paging Response message.
   Paging message from MSC is received by the IWF. The IWF build a specific UE-IWF Paging message in the EPC bearer established at Attach.
   If the UE is in LTE-idle mode, the S-GW will send Data Notification to the MME that will page the UE. The UE will answer with Service Request and all the EPC bearers will be automatically re-established. The Paging message, queued in the S-GW, will be delivered when the connectivity with the UE is established. The UE will answer by sending a NAS CS domain Paging Response message back to the MSC via the IWF.
   If the UE is in connected mode, the Paging message will be delivered immediately.

MO and MT SMS

FIG. 9 is intended to illustrate a SMS procedure according to an embodiment of the present invention.
MO and MT SMS signalling takes place as specified in TS 23.040
IWF is transparent to these messages—IWF only relays them with appropriate encapsulation:
   encapsulation in Direct Transfer messages over Iu
   encapsulation in IP packets with container over IWF-UE Z1 interface

Handover from E-UTRAN to GSM/UMTS CS

FIG. 10 is intended to illustrate a procedure for handover from UTRAN to GSM UMTS CS according to an embodiment of the present invention.
MME already knows UE CSoPS capability and informs the eNB that both UE and EPC are CSoPS capable at call setup. This allows the eNB to decide whether to initiate a CSoPS handover (to LTE target cell) or a PS handover (to CS only target cell). Could be similar mechanism as used in SR-VCC.
eNB is the decision point for handover. Measurement ordered to UE per TS 23.401. eNB sends HO Required to MME with an indication of whether the handover is CSoPS handover or PS handover.
CS source-target RAN Transparent Container to build by the IWF or the eNB
If CSoPS handover is indicated by the eNB, the MME relays the HO Required message to the IWF.
The handover proceeds between IWF and MSC as for legacy CS handover.

General: Similarly as in the SR-VCC mechanism where the UE sends the SR-VCC UE capability to the MME, and where the MME sends the “SRVCC operation possible” indication to the E-UTRAN inside the S1-AP Initial Context Setup Request message meaning that both UE and MME are SRVCC-capable, the E-UTRAN can be informed in the same way of the “CS over PS operation possible” (possibly with the same indicators as those used in SR-VCC). It allows the E-UTRAN to know whether the handover is a CS over PS handover (e.g. the target cell is a CS cell) or a PS handover (e.g. if the target cell is E-UTRAN cell).
0) A measurement report from the UE triggers the eNodeB to send a HO Required to the MME with an indication that this is an CS over PS handover operation. The MME forwards the HO Required to the IWF through Sv interface.
NOTE 1: The handover of other established non-voice bearers is handled by the MME according to the procedures for E-UTRAN to UMTS/GPRS Inter RAT handover as specified in TS 23.401.
1-8) Upon receiving the HO Required from the MME the IWF initiates a legacy handover towards the serving MSC. An inter-MSC handover may be performed if the target cell is under control of another MSC.
NOTE 2: If the currently serving MSC is also serving MSC of the target cell then no inter-MSC handover is needed and steps 2)), 5) and 6) are skipped.
7) The IWF initiates the release of the EPC bearers, which is done according to ‘IP-CAN Session Modification; PCRF initiated’ procedure as specified in TS 23.203.

Handover from GSM UMTS CS to E-UTRAN
May not be required in a first step
Requires that an EPS bearer be established at handover to be used for carrying 24.008 messages
   The IWF could establish an EPC (for example Default) Bearer when receiving Relocation Request from the MSC by requesting that bearer to PCRF via Rx interface.
   The IWF could ask the MME to establish these bearers per 23.401.
   Or the UE could establish it when arriving at the target E-UTRAN. This would avoid that the UE tries to send CS NAS messages to the MSC before the bearer is established.

Location Reporting Control
When the MSC sends a Location Report message, the IWF converts it into a new Sv message to the MME, requesting the location information in the LTE
The MME returns LTE location information to the IWF
The IWF maps the LTE location information returned by the MME to CS location information and sends Location Report back to MSC
The location information can be either Service Area or Geographical Information.

Co-Existence with IMS Based Services

It is expected that there will be UEs supporting both, CS domain services over PS access as well as IMS based services.

Operators may offer voice services over CS domain as well as over IMS in their network. For one specific user voice services can be provided in the CS Domain or in IMS, or in both. This would be part of the user's subscription information in the HSS, and operator controlled configured in the UE.

Concurrent access to CS Domain voice services and IMS non-voice services is possible. It is possible to combine CS and IP Multimedia Subsystem (IMS) services as specified in TS 23.279 when they are both accessed over EPS. The UE decides based on the operator controlled configuration in the UE about the preferred domain for voice services when adding a voice call to an ongoing IMS session.

VCC (as specified in TS 23.206) and ICS (as studied in TR 23.892) architectures and the here proposed architecture for CS Domain services over evolved PS access are mutually exclusive but can co-exist in operators networks; it is not expected that any functionality can be shared or re-used.

SR VCC (as studied in TR 23.882) may have overlapping functionality, depending on the selected architecture. The currently identified possible overlapping functionality is identifying and marking of voice bearers in EPS so that a later radio handover triggers an inter-MSC HO.
Note: It can be left open if this functionality will be specified in a way so that it can be shared between SR VCC and CS Domain services over evolved PS access.

Roaming Aspects—IWF Supports in the VPLMN

In this case voice calls are fully controlled by the VPLMN where PDN GW and IWF are located. This is the preferred roaming architecture for CS Domain services over evolved PS access. It allows full re-use of CS domain roaming agreements and existing inter-operator accounting mechanisms (TAP records exchange) for CS Domain voice services over evolved PS access. In case of a handover between E-UTRAN and GSM/UMTS CS the user experience will be comparable to the one in non-roaming case as the handover is performed solely in the VPLMN, which optimizes the user plane routing.

Roaming Aspects—No IWF Support in the VPLMN

In this case, depending on the operator's choice, the subscriber will either:
not have access to CS domain voice calls over EPS;
or have access to CS domain voice over EPS, but the handovers to UTRAN/GERAN cells will not be allowed as the IWF and serving MSC are located in the Home PLMN whilst the target MSC is located in the Visited PLMN.

Security Aspects

The EPS provides IP connectivity with integrity protection and ciphering, and an authenticated sender IP address.

At time of registration most operators will require that the MSC performs an Authentication Procedure to authenticate the (T)IMSI and the IWF to create a secure binding with the sender IP address by verifying that it matches the IP address provided by the MME.

At EPS Attach and at TAU, the MME selects a couple (IWF IP address, LAI) which identifies the MSC pool unambiguously. It sends a UE Binding message to the IWF through Sv interface with the TMSI/IMSI and the UE IP address. The binding verification is performed when the UE sends a CS Domain NAS message to the IWF, the NAS messages being encapsulated in IP packets that include UE IP address and TMSI/IMSI.

Charging Aspects

Charging shall be done in the MSC, using the standardized CS Domain interfaces and functions as specified in TS 32.250, TS 32.240, TS 32.299. In case of loss of transmission on the allocated EPC bearer for the voice stream the IWF will be triggered by the PCEF via Rx, and according to operator preference either stop charging, or terminate the call.

Charging in the EPS is done with the PCC architecture as specified in TS 23.203. It is expected that operators would zero-rate all signalling traffic to the IWF, as well as the EPC bearers transporting the voice traffic.

Legal Requirements Aspects—Emergency Calls

Following procedure describes an Emergency calls without UICC or without relevant roaming rights for an UE with CSoPS support.

The establishment of the UE-IWF-session between the UE and the IWF works as for the generic case but for following precisions:
1. The UE requests an “EPS emergency attach” (similar to the one that will be defined for support of IMS emergency calls without UICC or without relevant roaming rights). As part of this process, a default bearer is established via a relevant S-GW and P-GW
2. The MME (for an UE with CSoPS support), as part of this “EPS emergency attach” procedure, allocates an IWF (per CSoPS procedure for a normal attach), opens a connection with this IWF and indicates that this is for emergency service, sending to the IWF the identity of the mobile (e.g. the IMEI) received as part of the “EPS emergency attach” (instead of the temporary and permanent UE Identity in case of a normal attach).
3. When the UE establishes the UE-IWF-session, the UE provides its identity (e.g. the IMEI) sent as part of the “EPS emergency attach”. The IWF checks the mapping of this identity with the IP © of the UE received from the MME.
4. Afterwards the UE uses the services of the IWF to exchange signalling with the MSC per normal CSoPS procedure but the IWF checks that only 24.008 requests allowed by emergency services are transferred.
5. Furthermore when a dedicated bearer for emergency service is to be establishes, an emergency indication is provided over Rx to the PCRF in order to establish an EPS bearer with the relevant QoS.

Legal Requirements Aspects—Lawful Interception
For the non-roaming and roaming architecture with local break-out the lawful interception architecture and mechanisms specified for the CS domain are sufficient.
A radio handover triggering a domain change has no impact on lawful interception of an ongoing call.
For the roaming architecture with home-routed traffic (see FIG. 5.1.1.2-2) lawful interception needs further investigations, but would be done similar to IMS voice services with home-routed traffic.

In one aspect, there is provided an architecture for the support of CS domain services over a Packet only mobile system such as the Evolved Packet System.

In an embodiment, there is provided an architecture for the support of CS domain services over a Packet only mobile system such as the Evolved Packet System access, in a mobile communication system comprising an Evolved Packet System (EPS) and a CS domain in turn comprising at last one Mobile Switching Center MSC, said architecture comprising at least one Interworking Function IWF, such that IWF is perceived as a Radio Network Controller RNC or a Base Station Controller BTS by a MSC, and as an Application Server by the EPS.

In an embodiment, IWF is connected on the one hand to the EPS via a Packet Data Network Gateway PDN-GW through 3GPP SGi interface, and to a Policy and Charging Rules Function PCRF through Rx interface and on the other hand to a MSC via 3GPP Iu or 3GPP A interface, and IWF relays CS domain Non Access Stratum NAS signalling between PDN-GW and MSC.

In an embodiment, said architecture comprises an interface between a User Equipment UE and IWF referred to as Z interface, such that CS domain NAS signalling is sent via said interface, over EPS, encapsulated into IP packets and carried by an EPS bearer.

In an embodiment, IWF is connected to a Mobility Management Entity MME of EPS, via an evolved 3GPP Sv interface enabling signalling exchange between IWF and MME for CS domain handover preparation and execution.

In an embodiment, IWF is connected to a Mobility Management Entity MME of EPS, via an evolved 3GPP Sv interface enabling signalling exchange between MME and IWF to allow UE binding verification by IWF.

In an embodiment, user plane data are sent via said interface between UE and IWF, over EPS, using said CS domain services.

In another aspect, different methods are provided for the support of CS domain services over a Packet only mobile system such as the Evolved Packet System access, such as in particular a method for registering to the CS domain an User Equipment UE to enable CS domain services over Evolved PS access, a method for call setup, a method for handover from E-UTRAN to GERAN/UTRAN.

In an embodiment, a method for registering comprises:
a step wherein, after having attached to the EPS network or at EPS attachment, an User Equipment UE attaches and registers, or is attached and registered by the EPS network, to the CS domain to enable CS domain services.

In an embodiment, a method for registering comprises the steps of:
selection of IWF by MME
verification of UE binding by IWF
selection of MSC by the IWF.

In an embodiment, a method for registering comprises a step of:
Verifying the UE binding by checking whether the Temporary User Identity such as GUTI or Permanent User Identity such as IMSI received in UE-IWF messages corresponding to the UE IP address matches with the Temporary User Identity such as GUTI or Permanent User Identity such as IMSI provided by the MME in the UE-Binding message.

In an embodiment, a method for registering comprises a step of:
IWF discovery by a User Equipment UE.

In an embodiment, a method for registering comprises a step of:
UE establishing a UE-IWF reliable session with the IWF, for the sending of CS Domain NAS messages and of UE-IWF Paging messages between UE and IWF.

In an embodiment, a method for registering comprises:
a step wherein UE includes its CS over PS CsoPS capability in an Attach Request message sent for attaching to EPS.

In an embodiment, a method for registering comprises:
a step wherein, if a UE is CSoPS capable, a Mobility Management Entity MME of EPS selects an IWF and allocates a Location Area from the Tracking Area Identity TAI, and returns the IWF IP address and the Location Area Identity LAI to the UE with EPS Attach Accept or EPS Tracking Area Update Accept.

In an embodiment, a method for registering comprises a step of:
MME sending a UE-binding message to the IWF, this message comprising at least the UE IP address, the LAI and the Temporary User Identity (e.g. GUTI) or Permanent User Identity (e.g. IMSI).

In an embodiment, the CS Domain NAS messages between UE and IWF are encapsulated in UE-IWF messages that are based on IP packets and that include a UE-IWF specific header.

In an embodiment, said UE-IWF specific header comprises Temporary User Identity (e.g. GUTI) or Permanent User Identity (e.g. IMSI) is included in the IWF-UE messages in addition to CS Domain NAS messages.

In an embodiment, said UE-IWF specific header comprises also in the direction from UE to IWF the identifier of the cell where the UE is camping and where the IWF after having validated this information, translates it into Cell-Identification that it transfers in the relevant messages sent to the MSC on Iu or A interface.

In an embodiment, a method for registering comprises the steps of:
IWF verifying that Temporary User Identity (e.g. GUTI) or Permanent User Identity (e.g. IMSI) received in the UE-IWF messages from the UE matches with the Temporary User Identity (e.g. GUTI) or Permanent User Identity (e.g. IMSI) received in the MME-IWF UE-binding message,
IWF selecting an MSC among a pool of MSC's that handle the Location Area corresponding to the LAI sent by the MME.

In an embodiment, a method for registering comprises a step of:
IWF establishing a SCCP connection with the selected MSC, for the sending of CS Domain NAS messages encapsulated into RANAP or BSSMAP messages over said SCCP connection.

In an embodiment, a method for registering comprises a step of:
if the LAI is changed or not known by the UE, the UE initiates a registration procedure by sending a Location Updating Request to the IWF.

In an embodiment, a method for Location Update comprises a step of:
UE initiating Location Area LA Update if the Location Area Identity LAI provided in a EPS Attach Accept or in a EPS Tracking Area Update TAU is different from the LAI stored in the UE.

In an embodiment, a method for EPS Detach comprises a step of:
when the UE is detached from EPS, the MME releasing the connection with the IWF, allowing the IWF to release any resource associated with the UE such as the SCCP connection (associated with the UE) to the MSC, the EPS bearers established for the UE and the UE-IWF session with the UE.

In an embodiment, a method for EPS Mobility Management comprises the steps of:
In both idle and connected modes, a change of serving MME being signalled from the new MME to the IWF,
At MME change, the couple IWF IP address-LAI being transferred by the old MME to the new MME in the MM context.

In an embodiment, a method for call setup comprises a step of:
the call setup being transported over an UE-IWF session established between UE and IWF for the sending of CS Domain NAS messages and IWF-UE Paging messages between UE and IWF.

In an embodiment, a method for call setup comprises a step of:
upon receipt of RANAP RAB Assignment Request from the MSC, the IWF initiating the EPC bearer for the voice stream according to IP-CAN Session Modification-PCRF initiated procedure.

In an embodiment, a method for terminating call setup, comprises the steps of:
On receiving a Paging message from a MSC, the IWF building a IWF-UE Paging message and sends it to the UE.
On receiving a IWF-UE Paging message from the IWF, the EPC initiating a normal EPC paging process if the UE is not currently EPC connected
On receiving a IWF-UE Paging message from the IWF, the UE responding with a CS Domain NAS message indicating Paging Response message to the IWF.
On receiving the Paging Response from the UE, the IWF establishing a SCCP connection for the UE between the IWF and the MSC if not already established and sending a CS Domain NAS message indicating Paging Response to the MSC.

In an embodiment, a method for CSoPS handover possibility indication from MME to E-UTRAN comprises the steps of:
MME deciding whether a CSoPS handover is possible, based on UE CSoPS capability received from the UE and from the CSoPS network capability.
MME notifying the E-UTRAN during call setup phase that a CSoPS handover is possible.

In an embodiment, a method for handover from E-UTRAN to GSM/UMTS CS comprises a step of:
E-UTRAN deciding whether the handover is a CSoPS handover or a EPS PS handover.

In an embodiment, a method for handover from E-UTRAN to GSM/UMTS CS comprises the steps of:
E-UTRAN sending a HO Required to the MME with the indication that the handover is a CSoPS handover or a PS handover.
Upon receiving a HO Required from a E-UTRAN with an indication that the handover is a CSoPS handover, the MME sending a HO Required message to the IWF.
Upon receiving a HO Required from a MME the IWF initiating a legacy handover towards the serving MSC.

In an embodiment, a method for handover from GSM/UMTS CS to E-UTRAN comprises the steps of:
MSC sending legacy handover request towards IWF
Upon receiving a handover request from the MSC, the IWF sending an indication to the MME of a Forward Relocation Request with IWF acting as a serving SGSN
MME combining IWF originated request with parallel message from actual serving SGSN
MME ensuring that the relevant EPS bearers required by the CSoPS service of the UE are established
MME informing IWF of successful handover and of new UE-IWF binding.

In an embodiment, a method for Location Reporting Control between MSC and MME comprises the steps of:
IWF Translating a Location Reporting Control message received from the MSC into a Location Reporting Control message sent to the MME through the interface between MME and IWF,
On receiving the Location Report message from the MME, building a Location Report message and sending it as a response to the Location Reporting Control to the MSC.

In another aspect, different entities are provided for the support of CS domain services over a Packet only mobile system such as the Evolved Packet System access, such as in particular Interworking Function IWF, Mobility Management Entity MME for EPS, E-UTRAN entity such as in particular eNB, and User Equipment UE.

In an embodiment, an Interworking Function IWF is such that it is perceived as a Radio Network Controller RNC or a Base Station Controller BTS by a MSC, and as an Application Server by the EPS.

In an embodiment, an Interworking Function IWF is connected on the one hand to the EPS via a Packet Data Network Gateway PDN-GW through 3GPP SGi interface, and to a Policy and Charging Rules Function PCRF through 3GPP Rx interface and on the other hand to a MSC via 3GPP Iu or 3GPP A interface, and IWF relays CS domain Non Access Stratum NAS signalling between PDN-GW and MSC.

In an embodiment, an Interworking Function IWF is such that CS domain NAS signalling is sent over EPS, encapsulated into IP packets and carried by an EPS bearer, via an interface referred to as Z interface between a User Equipment UE and IWF.

In an embodiment, an Interworking Function IWF is connected to a Mobility Management Entity MME of EPS, via an evolved 3GPP Sv interface enabling signalling exchange between IWF and MME for CS domain handover preparation and execution.

In an embodiment, an Interworking Function IWF is connected to a Mobility Management Entity MME of EPS, via an evolved 3GPP Sv interface enabling signalling exchange between MME and IWF to allow UE binding verification by IWF.

In an embodiment, an Interworking Function IWF is such that user plane data are sent via said interface between UE and IWF, over EPS, using said CS domain services.

In an embodiment, an Interworking Function IWF is configured, for registering to the CS domain an User equipment UE to enable CS domain services over Evolved PS access:
for verification of UE binding
for MSC selection.

In an embodiment, an Interworking Function IWF is configured, for registering to the CS domain an User equipment UE to enable CS domain services over Evolved PS access:
for verifying the UE binding by checking whether the Temporary User Identity such as GUTI or Permanent User Identity such as IMSI received in UE-IWF messages corresponding to the UE IP address matches with the Temporary User Identity such as GUTI or Permanent User Identity such as IMSI provided by the MME in the UE-Binding message.

In an embodiment, an Interworking Function IWF is configured, for call setup:
for allowing the call setup to be transported over an UE-IWF session established between UE and IWF for the sending of CS Domain NAS messages and IWF-UE Paging messages between UE and IWF.

In an embodiment, an Interworking Function IWF is configured, for call setup:
for, upon receipt of RANAP RAB Assignment Request from the MSC, initiating the EPC bearer for the voice stream according to IP-CAN Session Modification-PCRF initiated procedure.

In an embodiment, an Interworking Function IWF is configured, for handover from E-UTRAN to GSM/UMTS CS:
for, upon receiving a HO Required from a MME, initiating a legacy handover towards the serving MSC.

In an embodiment, an Interworking Function IWF is configured:
for Relaying NAS signalling between an IP interface such as SGi with a terminal and an interface such as Iu or A with a MSC.

In an embodiment, an Interworking Function IWF is configured:
for acting as a RNC or a BSS for the MSC.

In an embodiment, an Interworking Function IWF is configured:
for translating radio resource assignment procedures received from a MSC such as RANAP RAB Assignment procedures to/from Establishment/Modifications/Releases of EPS bearers to PCRF through Rx.

In an embodiment, an Interworking Function IWF is configured:
for getting knowledge of CS over PS CSoPS UE capability.

In an embodiment, an Interworking Function IWF is configured:
for translating a Paging message from the MSC to a IWF-UE Paging message to be sent to the UE.

In an embodiment, an Interworking Function IWF is configured:
for relaying handover preparation and execution signalling messages between MME and MSC via an evolved Sv interface and Iu/A interface.

In an embodiment, an Interworking Function IWF is configured:
for verifying that Temporary User Identity (e.g. GUTI) or Permanent User Identity (e.g. IMSI) received in the UE-IWF messages from the UE matches with the Temporary User Identity (e.g. GUTI) or Permanent User Identity (e.g. IMSI) received in the MME-IWF UE-binding message.

In an embodiment, an Interworking Function IWF is configured:
for selecting a MSC from the LAI indicated by the MME.

In an embodiment, an Interworking Function IWF is configured:
for managing an “UE-IWF Session” established between UE and IWF for the sending of CS Domain NAS messages and IWF-UE Paging messages between UE and IWF.

In an embodiment, an Interworking Function IWF is configured:
for translating the Location Reporting Control message from the MSC into a Location Reporting Control message sent to MME.

In an embodiment, an Interworking Function IWF is configured:
for translating the Location Reporting message from the MME into a Location Reporting message to the MSC.

In an embodiment, an Interworking Function IWF is configured:
to check that an UE for which it has received from MME that only emergency service shall be granted, sends only emergency requests to the MSC.

In an embodiment, a Mobility Management Entity MME is such that IWF is connected to said Mobility Management Entity MME via an evolved 3GPP Sv interface enabling signalling exchange between IWF and MME for CS domain handover preparation and execution.

In an embodiment, a Mobility Management Entity MME is such that IWF is connected to said Mobility Management Entity MME via an evolved 3GPP Sv interface enabling signalling exchange between MME and IWF to allow UE binding verification by IWF.

In an embodiment, a Mobility Management Entity MME is configured, for registering to the CS domain an User equipment UE to enable CS domain services over Evolved PS access:
for IWF selection.

In an embodiment, a Mobility Management Entity MME is configured, for CSoPS handover possibility indication from MME to E-UTRAN:
for deciding whether a CSoPS handover is possible, based on UE CSoPS capability received from the UE and from the CSoPS network capability.
for notifying the E-UTRAN during call setup phase that a CSoPS handover is possible.

In an embodiment, a Mobility Management Entity MME is configured, for handover from E-UTRAN to GSM/UMTS CS:
for, upon receiving a HO Required from a E-UTRAN with an indication that the handover is a CSoPS handover, sending a HO Required message to the IWF.

In an embodiment, a Mobility Management Entity MME is configured:
for Selecting an IWF, and allocating an LAI to the UE.

In an embodiment, a Mobility Management Entity MME is configured:
for exchanging signalling with the IWF for CS domain handover preparation and execution through an evolved Sv interface.

In an embodiment, a Mobility Management Entity MME is configured:
for signalling to the IWF to allow UE binding verification by the IWF via an evolved Sv interface.

In an embodiment, a Mobility Management Entity MME is configured:
for signalling a change of MME to the IWF via Sv interface.

In an embodiment, a Mobility Management Entity MME is configured for:
at MME change, a source MME sending the IWF IP address to a target MME.

In an embodiment, a Mobility Management Entity MME is configured:
for Location reporting control procedures via Sv interface.

In an embodiment, an User Equipment UE is configured, for registering to the CS domain to enable CS domain services over Evolved PS access:
for, after having attached to the EPS network or at EPS attachment, attaching and registering, or being attached and registered by the EPS network, to the CS domain to enable CS domain services.

In an embodiment, an User Equipment UE is configured, for registering to the CS domain to enable CS domain services over Evolved PS access:
for IWF discovery.

In an embodiment, an User Equipment UE is configured, for call setup:
for allowing the call setup to be transported over an UE-IWF session established between UE and IWF for the sending of CS Domain NAS messages and IWF-UE Paging messages between UE and IWF.

In an embodiment, an User Equipment UE is configured:
for NAS CS domain signalling, including Mobility Management, Call Control and SMS, over IP transport.

In an embodiment, an User Equipment UE is configured:
for encapsulation of NAS CS domain signalling messages in container that is intended to carry e.g. IWF IP address and MSC identifier.

In an embodiment, an User Equipment UE is configured:
for transferring CSoPS UE capability to the MME at Attach.

In an embodiment, an E-UTRAN entity such as in particular eNB is configured, for handover from E-UTRAN to GSM/UMTS CS:
for deciding whether the handover is a CSoPS handover or a EPS PS handover.

In an embodiment, an E-UTRAN entity such as in particular eNB is configured, for handover from E-UTRAN to GSM/UMTS CS:
for sending a HG Required to the MME with the indication that the handover is a CSoPS handover or a PS handover.

In an embodiment, an E-UTRAN entity such as in particular eNB is configured
for decision of CSoPS handover or PS handover depending on target cell type.

In an embodiment, an E-UTRAN entity such as in particular eNB is configured
for carrying out similar mechanism as the one used for SR-VCC.

The detailed implementation of the above-mentioned configuration does not raise any special problem for a person skilled in the art, and therefore such configuration do not need to be more fully disclosed than has been made above, by their function, for a person skilled in the art.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. An architecture for the support of circuit switched CS domain services over a Packet only mobile system such as the Evolved Packet System access, in a mobile communication system comprising an Evolved Packet System EPS and a CS domain in turn comprising at least one Mobile Switching Center MSC, said architecture comprising at least one Interworking Function IWF, such that IWF is perceived as a Radio Network Controller RNC or a Base Station Controller by a MSC, and as an Application Server by the EPS.

2. An architecture according to claim 1, wherein IWF is connected on the one hand to the EPS via a Packet Data Network Gateway PDN-GW through 3GPP SGi interface, and to a Policy and Charging Rules Function PCRF through 3GPP Rx interface and on the other hand to a MSC via 3GPP Iu or 3GPP A interface, and IWF relays CS domain Non Access Stratum NAS signalling between PDN-GW and MSC.

3. An architecture according to claim 1, comprising an interface between a User Equipment UE and IWF referred to as Z interface, such that CS domain NAS signalling is sent via said interface, over EPS, encapsulated into IP packets and carried by an EPS bearer.

4. An architecture according to claim 1, wherein IWF is connected to a Mobility Management Entity MME of EPS, via an evolved 3GPP Sv interface enabling signalling exchange between IWF and MME for CS domain handover preparation and execution.

5. An architecture according to claim 1, wherein IWF is connected to a Mobility Management Entity MME of EPS, via an evolved 3GPP Sv interface enabling signalling exchange between MME and IWF to allow User Equipment UE binding verification by IWF.

6. A method for registering to a circuit switched CS domain a User Equipment UE, to enable CS domain services over Evolved Packet System EPS access, said method comprising:
a step wherein, after having attached to an EPS network or at EPS attachment, the User Equipment UE attaches and registers, or is attached and registered by the EPS network, to the CS domain to enable CS domain services.

7. A method for registering to a circuit switched CS domain a User Equipment UE to enable CS domain services over Evolved Packet System EPS access, said method comprising the steps of:
selection of Interworking Function IWF by Mobility Management Entity MME
verification of the UE binding by the IWF
selection of a Mobile Switching Center MSC by the IWF.

8. A method according to claim 7, comprising a step of:
verifying the UE binding by checking whether the Temporary User Identity such as GUTI or Permanent User Identity such as IMSI received in UE-IWF messages corresponding to the UE IP address matches with the Temporary User Identity such as GUTI or Permanent User Identity such as IMSI provided by the MME in the UE-Binding message.

9. A method for registering to a circuit switched CS domain a User Equipment UE, to enable CS domain services over Evolved Packet System EPS access, comprising a step of:
Interworking Function IWF discovery by the User Equipment UE.

10. A method for registering to a circuit switched CS domain a User Equipment UE, to enable CS domain services over Evolved Packet System EPS access, comprising a step of:
the UE establishing a UE-IWF reliable session with an Interworking Function IWF, for the sending of CS Domain NAS messages and of UE-IWF Paging messages between the UE and the IWF.

11. A method for call setup, said method comprising a step of:
the call setup being transported over an UE-IWF session established between User Equipment UE and Interworking Function IWF for the sending of circuit switched CS Domain NAS messages and IWF-UE Paging messages between UE and IWF.

12. A method for call setup comprising a step of:
upon receipt of RANAP RAB Assignment Request from a Mobile Switching Center MSC, an Interworking Function IWF initiating the EPC bearer for the voice stream according to IP-CAN Session Modification-PCRF initiated procedure.

13. A method for CSoPS handover possibility indication from a Mobility Management Function MME to E-UTRAN, said method comprising the steps of:
the MME deciding whether a CSoPS handover is possible, based on User Equipment UE CSoPS capability received from the UE and from the CSoPS network capability; and,
the MME notifying the E-UTRAN during call setup phase that a CSoPS handover is possible.

14. A method for handover from E-UTRAN to GSM/UMTS CS, said method comprising a step of:
E-UTRAN deciding whether the handover is a CSoPS handover or an EPS PS handover.

15. A method for handover from E-UTRAN to GSM/UMTS CS, said method comprising the steps of:
E-UTRAN sending a HO Required to a Mobility Management Entity MME with the indication that the handover is a CSoPS handover or a PS handover,
upon receiving a HO Required from a E-UTRAN with an indication that the handover is a CSoPS handover, the MME sending a HO Required message to an Interworking Function IWF; and,
upon receiving a HO Required from a the MME, the IWF initiating a legacy handover towards a serving Mobile Switching Center MSC.

16. (canceled)

17. A method according to claim 6 comprising using a configured Interworking Function IWF.

18. An architecture according to claim 1 further comprising a Mobility Management Entity MME for EPS.

19. A method according to claim 6 further comprising using a configured Mobility Management Entity MME for EPS.

20. An architecture according to claim 1 further comprising a User Equipment UE.

21. A method according to claim 6 further comprising using configured User Equipment UE.

22. An architecture according to claim 1 further comprising an E-UTRAN entity in particular eNB.

23. A method according to claim 6 further comprising using a configured E-UTRAN entity (eNB).
